(19) United States
(12) Patent Application Publication
(10) Pub. No.: US 2023/0394856 A1
(43) Pub. Date: Dec. 7, 2023

(54) METHOD FOR DETERMINING A MANIPULATION OR FORGERY OF AN OBJECT AND SYSTEM THEREFOR

(71) Applicant: ERICH UTSCH AG, Siegen (DE)

(72) Inventors: Bernd PFUNDSTEIN, Ehringshausen (DE); Slavtcho Metodiev BONEV, Mannheim (DE)

(21) Appl. No.: 18/026,500

(22) PCT Filed: Sep. 14, 2021
(86) PCT No.: PCT/EP2021/075255

§ 371 Date: Apr. 12, 2023

(30) Foreign Application Priority Data
Sep. 15, 2020 (DE) 10 2020 124 060.0

(51) Int. Cl. G06V 20/00; G07D 7/12; G07D 7/0043; G06V 10/75; G06V 10/24

(52) U.S. Cl. CPC G06V 20/95; G07D 7/12; G07D 7/0043; G06V 10/751; G06V 10/24; G07D 2207/00; G06V 20/625

(57) ABSTRACT

A method for determining a manipulation or forgery of an object which is identified with a graphical representation of an information, wherein the graphical representation of the information forms light and dark regions and the object has a surface having a contrasting, irregular microstructure. A system is also related, the system being suitable for carrying out the method according to the invention.

### CROSS-REFERENCE TO RELATED APPLICATIONS

This application is a 35 U.S.C. § 371 National Stage patent application of PCT/EP2021/075255 filed 14 Sep. 2021, which claims the benefit of German patent application 102020124060.0 filed 15 Sep. 2020, the disclosures of which are incorporated herein by reference in their entirety.

### TECHNICAL FIELD

The subject matter of the present disclosure is a method for determining a manipulation or forgery of an item which is identified using a graphical representation of information. Furthermore, the subject matter of the present disclosure is a system for determining a manipulation of an item which is identified using a graphical representation of information. The graphical representation of the information may in particular have the form of a 1D code, such as a barcode, or a 2D code, such as a QR code or a data matrix code. The information may however also be present in plain text. Furthermore, the subject matter of the disclosure is a method for detecting a copy of such an item, which has been made in an unauthorized manner.

### BACKGROUND

A wide range of methods are known from the prior art to verify the authenticity of a document which is provided with a graphical representation of information. Newer methods take advantage in particular of the fact that the surface of such a document already carries irregular structures in a test area, for example on account of production, which structures are characteristic for the specific document and cannot or can only with a very high technical outlay be replicated on a different document. In an alternative approach, the surface is provided with an artificial irregular structure in a test area in the course of a generic method, e.g. in that the surface in the test area is provided with a random pattern of colour splashes. For the examination of the authenticity of such a document, an unprocessed or processed reference photograph of the test area of the document is stored in a database in a registration step. In order to examine the authenticity of the document in a subsequent validation step, a further photograph of the test area of the document is created and compared with the reference photograph stored in the database. This technique is also known under the catchword “physical unclonable function” (abbr.: PUF).

A method for producing security labels is known for example from DE 103 04 805 A1, wherein these security labels contain a random pattern. This random pattern can be read in and a corresponding “fingerprint” can be created, which is then compared with the photographed pattern during the authentication. The random distribution of particles is mentioned as an example, inter alia. In addition, a unique identification number may be used together with the “fingerprint”. The extracted fingerprint can furthermore also be stored again itself in a suitable graphical representation on the object to be identified.

WO 2019/197628 A1 proposes an overlay of a data matrix code or other reference structures with such a “fingerprint”. In general terms, this document describes a method for an optical product authentication. In this case, the product may be coated with a film which contains randomly distributed reflective and/or luminescent particles. This particle distribution is recorded and stored as a reference image. Subsequently, a detection image can be compared with the previously stored reference image. Furthermore, an overlay of the particles with a QR code is disclosed, wherein the QR code should be used to enable a digital image registration between the detection image and the reference image.

An overlay of this type is furthermore known from the laid open specifications US 2017/0132465 A1 and DE 10 2015 219 400 A1, which likewise form the generic type.

A disadvantage of the methods known from the prior art is that although they enable a verification of the authenticity of the item carrying the information, they do not enable a verification of the authenticity of the information itself.

### SUMMARY

This is the starting point for the present disclosure. The present disclosure provides a method for determining a manipulation of an item which is identified using a graphical representation of information. Furthermore, the present disclosure provides a system for determining a manipulation of an item which is identified using a graphical representation of information. In both cases, the manipulation may relate both to the item itself and the graphical representation of the information.

This is achieved by providing a method with the features of claim 1 and by a system with the features of claim 19.

It is to be noted, that the features detailed individually in the claims can be combined in any desired, technically sensible, manner with one another (also beyond category boundaries, for example between method and device) and indicate further embodiments of the disclosure. The description additionally characterizes and specifies the disclosure in connection with the figures in particular.

It should further be noted that a conjunction “and/or” used here, and standing between two features and linking the same to one another, is always to be understood to mean that in a first embodiment of the subject matter according to the disclosure, only the first feature may be present, in a second embodiment only the second feature may be present, and in a third embodiment both the first and the second feature may be present.

The term “approximately” used in the present application indicates a tolerance range, which the person skilled in the art working in the present field will consider conventional. In particular, the term “approximately” is to be understood to mean a tolerance range of the relevant value of up to +/−20% maximum, preferably up to +/−10% maximum.

The method according to the disclosure is provided for the forgery proof identification of an item using a graphical representation of information, wherein the information may for example be a serial number of the item identified using the information. In the scope of the present disclosure, a serial number should be understood to mean any desired identifier which uniquely identifies the identified item. The information may however also relate to the identity of the producer or distributor of the item or the holder or owner of the item. In the scope of the present disclosure, the scope of the information is fundamentally not limited.

A determination of a manipulation of an item, which is identified using a graphical representation of information, should be understood in the scope of the present disclosure to mean that an examination is possible as to whether
the graphical representation of the information on the item has been changed, or
it is a changed item which has been provided with the identical identifier, or
it is a changed item, on which the graphical representation of the information has furthermore been changed.

Particularly preferably, the item provided with a forgery proof identifier is an official document, e.g. a driving license, an official certification or an identification document, such as an identity card or a passport; a means of payment, such as a banknote, a credit card or a cheque; a security; an official registration document, such as a registration certificate or an official proof of validity, such as e.g. registration papers or a vignette for road use; or a vehicle number plate. In addition to a number plate which has a registration and possibly an official seal and is to be attached to the exterior of a vehicle, a motor vehicle number plate may also be what is known as a 3rd number plate, which is provided for arrangement in the interior of a motor vehicle.

It is essential for the disclosure that the item has a surface with a contrast-imparting, irregular microstructure. In this case, a contrast-imparting microstructure is understood to mean a structure which can be detected by means of optical means. In particular, such a microstructure should be detectable on the basis of an optical image of the relevant surface region, e.g. by means of a photographic image. The structural size of such a microstructure should in this case preferably be smaller than the characteristic dimensions of the graphical illustration of the information.

The contrast-imparting microstructure may in this case already have been created during the production of the item, in particular it may be an inherent product feature of the item, for example caused by fibres present in the item. In this case, the characteristic dimensions of the graphical illustration of the information are advantageously adapted to the structural size of the microstructure.

Mention may be made by way of example for this of an item, which is based on disordered fibres, e.g. a paper-based document, or an item, on the surface of which small particles are arranged, particularly embedded, e.g. a retroreflective film, which is based on spherical transparent beads, which are embedded into a transparent matrix. In particular, such an item may be a retroreflective motor vehicle number plate, which may be provided with an individual registration in particular.

The contrast-imparting microstructure may however also have been created on or in the item in preceding method steps, e.g. by means of a suitable printing method, e.g. by means of the printing method known from DE 103 04 805 A1. In this case, the structural size of the microstructure created is advantageously chosen to be adapted to the desired characteristic dimensions of the graphical illustration of the information.

The disclosure assumes that a graphical representation of the information is present, particularly in plain text or in the form of a 1D code, such as a barcode, or a 2D code, such as a QR code or a data matrix code.

An advantageous development of the method according to the disclosure furthermore comprises the method step of generating a graphical representation of the information.

Furthermore, the disclosure assumes that the item is identified using the graphical representation of the information, wherein areas are formed, which have a machine-detectable contrast to the surrounding surface regions of the item.

In particular, the previously mentioned contrast-imparting microstructure of the surface of the item can also be created in that the item has a microstructure in its interior, which during the application of the graphical representation of the information to the item leads to the formation of a contrast-imparting microstructure on the surface of the item, which then becomes visible, i.e. detectable by means of image processing. This may be the case in particular if the graphical representation of the information is created by means of laser marking of the item.

A further advantageous development of the method according to the disclosure therefore comprises the method step of identifying the item using the graphical representation of the information.

During the identification of the item using the graphical representation of the information, areas are formed on the item by suitable treatment, such as laser irradiation or printing, which areas are optically detectable on the surface of the item against the background of the untreated surface of the item. These areas have a machine-detectable contrast to the surrounding surface regions of the item. In particular, an area which has a machine-detectable contrast to the surrounding surface regions of the item may be a surface region, the brightness value or colour value of which differs in a measurable manner from that of the surrounding surface regions of the item.

To simplify the language used, in the scope of the present disclosure, this is termed the formation of brighter and darker areas, as at least the brightness values or the colour values of these areas differ from one another in a measurable manner.

In particular, the bright areas may be formed by the untreated background of the area of the item provided with the graphical representation of the information.

In particular, the dark areas may be formed by the treated surface regions. They may appear black in particular.

It is noted that particularly in the case of 1D and 2D codes, generally both the bright and the dark areas of the respective code encode the contained information.

In a first method section which is termed product registration in the following, the method according to the disclosure has the following method steps:
a. creation of a first photograph of the surface region of the item, in which the graphical representation of the information is arranged,
b. spatially resolved analysis of the first photograph in the bright or/and in the dark areas, in order to generate a reference identifier,
c. provision of the reference identifier in a data structure.

These method steps are generally only executed once, typically in a close temporal relationship with the application of the graphical representation of the information on the item.

The subsequent method steps, which are used for product validation, are executed subsequently, in order to examine whether an item—which at least according to a first impression is identical to the item identified using the graphical illustration of the information in the first steps—is actually the item identified in the context of the product registration or whether the item is identified using the information which was applied to the registered item during the product registration. The method only delivers a positive test result if the validated item is actually the registered item and if the product validation shows that the information with which the validated item is identified is identical to the information arranged on the registered item in the registration step.

To this end, in a second method section, which is termed product validation in the following, the method according to the disclosure has the following further method steps:
d. creation of a test photograph of the surface region of an item to be validated, in which the graphical representation of information is arranged,
e. spatially resolved analysis of the test photograph of the surface region in the bright or/and in the dark areas, in order to generate a test identifier,
f. retrieval of a reference identifier from the data structure,
g. execution of a method for determining the degree of matching between the test identifier and the reference identifier retrieved from the data structure, and
h. categorization of the information or/and the item as
   A. “not manipulated”, if at least one preset minimum degree of matching is achieved, or
   B. “manipulated”, if a preset minimum degree of matching is not achieved.

It is noted that in the context of the method according to the disclosure an extraction of the information from the test photograph does not necessarily have to take place. Nevertheless, the method makes it possible to categorize the information applied to the item as manipulated/not manipulated.

In a first advantageous embodiment of the method according to the disclosure, the reference identifier is stored together with the information in the data structure during the product registration. In a subsequent validation step, in step f., the reference identifier on which the validation is based is retrieved on the basis of the information from the data structure.

This procedure makes it possible to retrieve an identifier stored in the data structure in a targeted resource-saving manner, which identifier is assigned to the item to be validated. In particular, the method for determining the degree of matching between the test identifier and the reference identifier retrieved from the data structure must only be executed a single time in this embodiment.

In a second embodiment of the method according to the disclosure, the information is not stored together with the reference identifier in the data structure during the product registration. Therefore, without further measures, there is no option available to retrieve a reference identifier, which should be called upon for the validation, from the database in a targeted manner. In this embodiment of the method, the method for determining the degree of matching between the test identifier and the reference identifier retrieved from the data structure is therefore generally executed repeatedly, specifically until either, in method step h., extracted information delivers the result “not manipulated” or until all reference identifiers stored in the data structure have been categorized as “manipulated”.

In the first case, the examined item is the item registered during product registration and the extracted information is the information which was arranged on the registered item during the product registration. Therefore, no manipulation or forgery is present.

In the second case, the examined item is either not the item registered during the product registration or/and the extracted information is not the information which was arranged on the registered item during the product registration. Therefore, a manipulation or forgery is present.

In a preferred embodiment of the present disclosure, the data structure is located on the item itself. In the simplest case, the data structure is formed directly as a graphical encoding of the reference identifier, which is arranged on the item in a suitable manner. 1D codes, such as barcodes, or 2D codes, such as QR codes or data matrix codes, have for example proven suitable as graphical encodings.

In an alternative embodiment, plain text is used as a graphical encoding of the reference identifier.

Preferably, the arrangement of the graphical encoding on the item takes place in such a manner that a manipulation of the graphical encoding is more difficult. This can be achieved in that the identifier is applied to the item by means of a local irreversible change of the material of the item, e.g. by means of laser inscription. Such a laser inscription may in particular also be introduced into the material of the item and is not limited to a purely superficial change of the material of the item.

This is advantageous in particular if the item is constructed to be at least partially transparent, e.g. in that it has a transparent layer on the surface, which may for example be formed as a (partially) transparent film.

Also possible however is arranging the graphical encoding on the item by means of a suitable printing, embossing, engraving or stamping method.

In an alternative preferred embodiment, the data structure is formed as a memory chip, which is fixedly connected to the item. In particular, this may be a memory chip, the memory content of which can be read out by means of wireless communication, for example an RFID chip or an NFC chip. The reference identifier is stored on the memory chip in digital form and can be retrieved from the same by means of suitable readers.

In a preferred development, the reference identifier is stored on the memory chip in an encrypted manner.

In a further preferred embodiment, the memory chip is set up for an encrypted wireless communication with a suitable reader.

In an alternative preferred embodiment of the present disclosure, the data structure is formed separately from the item.

In a first embodiment, the data structure is formed analogously to the preceding embodiment, i.e. as a graphical encoding or as a reference identifier stored in digital form on a suitable memory chip. However, in deviation from the first embodiment, the data structure is not formed on the item itself, but rather on a separately formed item. Preferably, in proper use, the item and the further separately formed item are arranged separately from one another. As an example for this, in terms of an item, mention may be made of a motor vehicle number plate with registration, which is conventional around the world, for attachment to the exterior of a motor vehicle, and in terms of a further separately formed item, mention may be made of a “third number plate”, which is likewise conventional in many states and is typically arranged in the interior of a motor vehicle, e.g. on the windscreen or a side window of the motor vehicle.

In a second embodiment, the data structure is formed as a database, which can be addressed by a suitably formed reader via a network, in order to access data stored in the database, particularly reference identifiers, at least in a reading manner.

The database can in particular be stored on a medium, which is connected to the internet or a different digital communications network, for example a server or a network-attached storage medium, which may both advantageously be cloud-based.

The method according to the disclosure offers a very high degree of forgery protection due to the interleaving of encoded information with the irregular microstructure of the item. This means that it is possible to assume with great certainty the authenticity of the validated item and the encoded information arranged there, if the extracted information is categorized as “not manipulated” by means of the method according to the disclosure.

It is noted that in many use cases, following product validation, further processing of the information arranged on the item is not required. These use cases are characterized in that they are primarily used for examining the authenticity of the item identified using the information. The examination of the authenticity of a means of payment or an official document or else the examination of the authenticity of a motor vehicle number plate may be mentioned by way of example for this.

Furthermore, there are of course also use cases in which the information arranged on the item in encoded form is desirable or required. A particularly preferred development of the method according to the disclosure relates to these use cases. In this development, the method comprises the following further method steps:
a. extraction of the information encoded in the graphical representation, and
b. provision of the extracted information for further processing.

These method steps are preferably executed only if the extracted information was categorized as “not manipulated” during the product validation.

These method steps may however also be executed advantageously in the context of the product validation.

This is particularly advantageous if during the product registration, the reference identifier was linked with the information in such a manner when it was stored in the data structure, that it is possible to retrieve the linked reference identifier from the data structure by specifying the information. In this manner, the one reference identifier, which is linked with the item to be examined, can be retrieved from the data structure during the product validation in a targeted manner by specifying the information decoded from the graphical identification. This is advantageous in particular if not only a single reference identifier, but rather a multiplicity of reference identifiers is stored in the data structure, which would otherwise have to be checked for matching with the test identifier in the context of the method according to the disclosure, until either a positive test result is present, i.e. at least one preset minimum degree of matching is achieved, or until the comparison of the test identifier with all of the reference identifiers stored in the data structure has delivered a negative test result. This development of the method according to the disclosure therefore enables a particularly resource-conserving procedure.

In a preferred development of the method according to the disclosure, a position correction of the photograph to be analysed is carried out during the spatially resolved analysis of the reference photograph or/and the test photograph in the bright or/and in the dark areas. This may be used in particular to ensure a matching orientation of the graphical representation of the information present both in the reference photograph and the test photograph. As a result, the carrying out of the method to be carried out according to the disclosure for determining the degree of matching between reference photograph and image capture is simplified significantly. Furthermore, the method can achieve more reliable results.

In a further preferred development of the method according to the disclosure, a size correction of the photograph to be analysed is carried out during the spatially resolved analysis of the reference photograph or/and the test photograph in the bright or/and in the dark areas. This may be used in particular to ensure a matching size of the graphical representation of the information present both in the reference photograph and the test photograph. Also, as a result, the carrying out of the method to be carried out according to the disclosure for determining the degree of matching between reference photograph and test photograph is simplified significantly. Furthermore, the method can once again achieve more reliable results.

Preferably, both the previously mentioned position correction and the previously mentioned size correction are carried out on the basis of at least one subset of the bright or/and dark areas. However, all bright or/and dark areas, of which the graphical representation of the information consists, may also be called upon for the previously mentioned correction steps.

The previously mentioned correction steps can be executed in a particularly simple manner if the graphical representation of the information is present in the form of a standardized machine-readable script, particularly in the form of a 1D code, such as a barcode, or a 2D code, such as a QR code or a data matrix code.

However, the use of standardized markers in the graphical representation of the information, which indicate the position or/and size thereof, has proven advantageous, particularly if the graphical representation of the information is not present in the form of a standardized machine-readable script.

In a further preferred development of the method according to the disclosure, during the spatially resolved analysis of the reference or/and test photograph in the bright or/and in the dark areas, the analysed bright or/and the dark areas are broken down into a predetermined number of subsections, wherein these subsections particularly preferably have the same size.

Particularly preferably in this case, the characteristic dimensions of the subsections are chosen such that they are larger than the structural size of the microstructure which is located on the item and to which recourse is made in the context of the method according to the disclosure. Preferably, the characteristic dimensions of the subsections are at least twice as large as the structural size of the microstructure, particularly preferably at least five-times as large and in particular preferably at least ten-times as large.

This procedure allows an efficient spatially resolved analysis of the reference or test photograph and therefore also allows the use of less performant test devices for carrying out the product validation.

In an advantageous development, during the spatially resolved analysis of the reference or/and test photograph, a brightness or colour value is assigned to the analysed image sections.

In particular, it has been established as advantageous if the respectively generated identifier is at least also based on the assigned brightness or colour values of the analysed image sections.

Furthermore, it has been established as advantageous if the respectively generated identifier is at least also based on identifiers which identify the analysed image sections. For example, these identifiers may number the image sections consecutively or denote the position of the individual image sections in a reference coordinate system.

It should be noted that with respect to method-related term definitions, as well as the effects and advantages of features according to the method, reference is made in full to the disclosure of corresponding definitions, effects and advantages of the method according to the disclosure. Accordingly, disclosures herein relating to the method according to the disclosure may be called upon in a corresponding manner for the definition of the system according to the disclosure, insofar as this is not explicitly excluded. Also, the following disclosures relating to the system according to the disclosure may be called upon in a corresponding manner for the definition of the method according to the disclosure. In this respect, it is possible to dispense with repetition of explanations of features which are the same in terms of meaning, the effects thereof and advantages of the method according to the disclosure and the system according to the disclosure, for the benefit of a more compact description, without such omissions being construed as a limitation.

A system according to the disclosure is provided for determining a manipulation of an item, which is identified using a graphical representation of information, the item being identified using a graphical representation of the information, particularly in plain text or in the form of a 1D code, such as a barcode, or a 2D code, such as a QR code or a data matrix code, with the formation of bright and dark areas. Furthermore, the mode of operation of the system according to the disclosure is based on the item having a surface with a contrast-imparting, irregular microstructure.

The system according to the disclosure has at least the following components:
a. a camera, which is suitable for creating a photograph of the surface region of the item, in which the graphical representation of the information is arranged, the resolution of the camera being sufficient for resolving the irregular microstructure,
b. an analysis unit, which is set up to analyse photographs created by the camera of the surface region of the item, in which the graphical representation of the information is arranged, in the bright or/and in the dark areas in a spatially resolved manner, in order to generate an identifier,
c. a data structure, in which at least one identifier can be provided,
d. a means for retrieving an identifier from the data structure,
e. a comparison unit, which is set up for executing a method for determining the degree of matching between two identifiers generated from different photographs of a surface region of one item in each case, in which the graphical representation of the information is arranged,
f. a categorization unit, which is set up to categorize the information arranged on the item or/and the item itself on the basis of the result of the method executed by the comparison unit, as follows:
   i. “not manipulated”, if at least one preset minimum degree of matching is achieved, or as
   ii. “manipulated”, if a preset minimum degree of matching is not achieved.

In a preferred embodiment, the analysis unit, the decoding unit, the comparison unit or/and the categorization unit are realized in a software-implemented manner.

In a preferred development, at least two functional units of the group consisting of analysis unit, decoding unit, comparison unit and categorization unit are formed in a common device, preferably at least three functional units and particularly preferably all four functional units.

Particularly preferably, the previously mentioned device is designed to be portable, particularly as a notebook, as a tablet computer, as a mobile digital device or as a smartphone.

In a further preferred embodiment of the disclosure, the previously mentioned device is integrated into a machine for mechanically treating the item. Mechanical treatment is for example understood to mean printing, laminating, engraving or mechanical forming.

In an advantageous development, it is provided that the mechanical treatment of the item by the relevant machine is only approved if the examined item has been recognized as “not forged” or “not manipulated” by means of the method according to the disclosure.

In particular, the previously mentioned device can be integrated into a number plate press which is set up to provide a motor vehicle number plate with a printed or preferably embossed number plate registration.

Further preferably, the camera of the system according to the disclosure is integrated into the previously mentioned device.

Alternatively, the camera can also be formed separately from the previously mentioned device. Preferably, the camera in this embodiment is arranged in a portable device in the form of a handheld device, which is suitable for being carried constantly by a person entrusted with the testing task, particularly in a mobile telephone or a tablet computer.

Furthermore, the camera, which is formed separately from the previously mentioned device, is set up for wireless or wired communication with the previously mentioned device, particularly via a wired or wireless IP-based communications network, such as a mobile network or via a short-range wireless communications network such as WiFi or Bluetooth®.

The camera may be suitable or even optimized for use in the visible spectral region.

Alternatively or additionally, the camera may be set up to operate outside the visible spectral range, particularly in the IR or in the UV range. This is particularly advantageous if the graphical representation of the information is arranged in such a manner on the item, that a satisfactory contrast for carrying out the method according to the disclosure results only or in particular in at least one of the spectral ranges mentioned.

In an advantageous embodiment of the method, a photograph of the graphical representation of the information is created in the visible spectral range.

In an alternative advantageous embodiment of the method, a photograph of the graphical representation of the information is created outside of the visible spectral range, particularly in the IR or UV range.

The camera preferably has a control unit, which is set up to trigger the taking of an image using the camera only if light conditions are satisfactory. In the context of the present disclosure, satisfactory light conditions is to be understood to mean that a photograph, created under light conditions of this type, of the surface region of the item, in which the graphical representation of the information is arranged, can be analysed reliably by the analysis unit.

In an advantageous development, the system according to the disclosure furthermore has a decoding unit, which is set up to extract from a photograph—which is created by the camera—of the surface region of the item in which the graphical representation of the information is arranged, the information encoded therein.

In an advantageous development of the system according to the disclosure, the same is set up to provide the information extracted by the decoding unit for further processing. In particular, the decoding unit can be designed in a suitable manner for this. In particular, the system according to the disclosure may form a suitable interface for this.

In an further advantageous development of the system according to the disclosure, the same furthermore has a non-volatile memory unit for accommodating the data structure.

In an embodiment of the previously mentioned development of the system according to the disclosure, the non-volatile memory unit is arranged on the item itself.

In an alternative embodiment of the previously mentioned development of the system according to the disclosure, the non-volatile data structure is formed separately from the item.

In a particularly advantageous embodiment of the system according to the disclosure, the data structure is set up such that an identifier can be stored in the data structure together with the information.

In a particularly advantageous development of the previously mentioned embodiment, the data structure is formed such that an identifier stored in the data structure can be retrieved from the data structure on the basis of the information.

Advantageously, the information used in a system according to the disclosure relates to one of the following parameters:
a. a serial number of the item or a further item correlated with the item,
b. the identity of the holder of the item.

By way of example, mention may be made here of the serial number of a motor vehicle number plate and, as an item correlated with the motor vehicle number plate, of a motor vehicle, which is identified uniquely by a serial number in the form of a chassis number.

In a particularly preferred embodiment of the system according to the disclosure, the surface of the item is coated with a glass-bead-based retroreflective film, as is sold for example by the company 3M under the name “Preclear Reflective License Plate Sheeting Series 4790”. Comparable films are also sold by the company Avery Dennison and by the company Orafol. Glass-bead-based retroreflective films are based on a multiplicity of transparent and non-transparent microscopic glass beads, which are arranged in the plane of the film and embedded into a transparent polymer binder layer. At the rear side, this layer is mirrored, for example by means of a thin metallic layer, which may consist of aluminium in particular. The transparent glass beads act as spherical lenses, behind which a reflector is arranged in each case, so that the focal point of the spherical lens is located on the reflector, which results in the retroreflective property of such a film.

The item is particularly advantageously a motor vehicle number plate, which may be designed to be retroreflective in particular. The item may further advantageously be an official document or a means of payment.

In an advantageous development, the system furthermore has position correction means. The position correction means are set up to carry out a position correction of the photograph to be analysed during the spatially resolved analysis of a photograph of the surface region of the item in which the graphical representation of the information is arranged.

The position correction means are set up to carry out the position correction on the basis of at least a subset of the bright or/and dark areas, preferably however all of the bright or/and dark areas.

In a further preferred development of the system according to the disclosure, the system has size correction means. The size correction means are set up to carry out a size correction of the photograph to be analysed during the spatially resolved analysis of the reference photograph or/and the test photograph in the bright or/and in the dark areas. This may be used in particular to ensure a matching size of the graphical representation of the information present both in the reference photograph and the test photograph. Also, as a result, the determination, to be carried out according to the disclosure, of the degree of matching between reference photograph and test photograph is simplified significantly. In this manner, a system is created, which makes it possible to achieve more reliable test results again.

In a particularly preferred development of the system according to the disclosure, the analysis unit is set up, during the spatially resolved analysis of a photograph, created by the camera, of the surface region of the item in which the graphical representation of the information is arranged, to break down the analysed bright or/and dark areas into a predetermined number of subsections.

In this embodiment, it proved particularly advantageous if the analysis unit is set up to assign a brightness or colour value to the analysed subsections.

Under the previously mentioned conditions, a particularly advantageous system results if an identifier generated by the analysis unit is at least also based on the assigned brightness or colour values.

Further advantages may result if an identifier generated by the analysis unit is furthermore based on identifiers which the analysed image sections identify.

In a particularly preferred embodiment, the system according to the disclosure has two functional units which are formed separately from one another.

It is noted that the applicant reserves the right to formulate coordinate claims, which are aimed at the first or the second functional unit in isolation or at a system which has both a first and a second functional unit. These subjects are considered by the applicant as belonging to the present disclosure.

A first functional unit is provided for carrying out a product registration and has the following:
a. a camera, which is suitable for creating a photograph of the surface region of the item, in which the graphical representation of the information is arranged, the resolution of the camera being sufficient for resolving the irregular microstructure,
b. an analysis unit, which is set up to analyse photographs created by the camera of the surface region of the item, in which the graphical representation of the information is arranged, in the bright or/and in the dark areas in a spatially resolved manner, in order to generate an identifier,
c. a data structure, in which at least one identifier can be provided.

A second functional unit is provided for carrying out a product validation and has the following:
a. a camera, which is suitable for creating a photograph of the surface region of the item, in which the graphical representation of the information is arranged, the resolution of the camera being sufficient for resolving the irregular microstructure,
b. an analysis unit, which is set up to analyse photographs created by the camera of the surface region of the item, in which the graphical representation of the information is arranged, in the bright or/and in the dark areas in a spatially resolved manner, in order to generate an identifier,
d. a means for retrieving an identifier from the data structure,
e. a comparison unit, which is set up for executing a method for determining the degree of matching between two identifiers generated from different photographs of a surface region of one item in each case, in which the graphical representation of the information is arranged, and
f. a categorization unit, which is set up to categorize the information arranged on the item or/and the item itself on the basis of the result of the method executed by the comparison unit, as follows:
   i. “not manipulated”, if at least one preset minimum degree of matching is achieved, or as
   ii. “manipulated”, if a preset minimum degree of matching is not achieved.

The first functional unit is preferably formed as a stationary unit and further preferably arranged spatially adjacent to or in the production facility in which the item identified using the graphical representation of the information is produced.

The second functional unit is preferably formed as a mobile unit and provided to be used in the field for examining the authenticity of items or information arranged thereon, preferably by means of the method according to the disclosure. In particular, the second functional unit can be formed in the form of a handheld device, which is suitable to always be carried by a person entrusted with the testing task.

In a further embodiment according to the disclosure, it is provided that the camera of the first functional unit and the camera of the second functional unit are identical, i.e. that the first and the second functional unit share a common camera.

In a first advantageous embodiment of the second functional unit, all of the means provided according to the disclosure are arranged in a single device, particularly in a mobile unit, as described previously. In this embodiment, a product validation can also be carried out reliably if there is no network connection to a central registration authority. As a result, reliable functioning is ensured, even in areas with insufficient mobile network coverage.

In this first embodiment of the second functional unit, it may be provided to accommodate the entire data structure on the single device of the second functional unit. In this case, the data structure comprises the database, in which at least the identifiers of all registered items (i.e. the totality of all detected identifiers), but preferably also the associated information in each case, are stored.

In a specific development, the database assigned to the data structure comprises only a subgroup of the identifiers of all registered items. This subgroup may be limited to items which are assigned to a selected user group. Mention may be made by way of example here of the motor vehicle number plates of a police or military unit.

The single device of the second functional unit is advantageously set up to automatically compare the data version of the data structure with that of a central registration authority as soon as a preferably IP-based communication is established between the device and the central registration authority.

In the previously described first advantageous embodiment, a product validation can also be carried out reliably if there is no network connection to a central registration authority. As a result, reliable functioning is ensured, even in areas with insufficient mobile network coverage.

In a second advantageous embodiment of the second functional unit, the means provided according to the disclosure are distributed to at least two devices. The camera is arranged in a mobile unit, as described previously.

All further means provided according to the disclosure are arranged in a separately formed stationary unit, with which the mobile unit is in data communication, advantageously via an in particular IP-based communications network.

The mobile unit is set up to transmit photographs which were taken by the camera arranged in the mobile unit, to the stationary unit via the data communications connection. The steps required for product validation are then executed in the stationary unit.

Preferably, the stationary unit is set up to transmit the result of the product validation carried out to the mobile unit via the data communications connection. There, the transmitted test result is brought to the attention of a user, e.g. via a display unit integrated into the mobile unit.

In this embodiment, all security-relevant constituents of the system according to the disclosure can be arranged in the stationary unit, where they can be protected from unauthorized access of third parties considerably more easily.

The previously described stationary unit does not necessarily have to be stationary in the sense that it could not be transported from one location to another. Actually, in an advantageous embodiment, the stationary unit is arranged on a mobile computer, which—unlike the mobile unit—can be isolated from access by unauthorized third parties in a simple manner, e.g. by arrangement in the protected interior of a motor vehicle. Also, a fixed mechanical connection to the motor vehicle can be realized in a simple manner.

Also, such a “stationary” unit furthermore offers the advantage that it can readily be equipped with a sufficiently large data memory to accommodate the data structure. In this case, the data structure comprises the database, in which the at least the identifiers of all registered items (i.e. the totality of all detected identifiers), but preferably also the associated information in each case, are stored. However, a limited database is also possible, in which only a subset of all registered items (i.e. the totality of all detected identifiers), but preferably also the associated information in each case, is stored.

If the item to be tested is actually a motor vehicle number plate which is attached to a motor vehicle, then the following development of the method according to the disclosure and the system according to the disclosure has been established as particularly advantageous:

Owing to the harsh use conditions of motor vehicle number plates, damage to the plate surface in the region of the graphical representation of the information, which is applied to the plate, cannot be excluded completely. This is true in particular for motor vehicle number plates, which are attached to the vehicle front. In the case of an examination by means of the method or system according to the disclosure, under certain circumstances, this would have a falsely negative validation result as a consequence. In order to minimize this risk, it is provided in an advantageous development, in accordance with the disclosure to register and to call upon for a product validation not just one, but rather all (generally two) motor vehicle number plates provided on the vehicle. The method according to the disclosure is extended by a test step, in which it is examined whether the results of all product validations that were carried out match or/and whether at least one positive result of a product validation is present. If this is the case, then a positive test result is generated for the vehicle equipped with the examined motor vehicle number plates (“number plate OK”). Advantageously, a warning notification for a user is additionally generated, which notifies of the presence of a negative test notification, so that if appropriate, a more precise examination of the motor vehicle number plate, which has been judged as defective, can take place.

If two matching negative test results are present, then a negative test result is generated for the vehicle equipped with the examined motor vehicle number plate (“number plate not OK”).

The system is extended by a suitable means for executing such a test step.

### BRIEF DESCRIPTION OF THE DRAWINGS

Further features and advantages of the disclosure emerge from the following description of exemplary embodiments of the disclosure, which are not to be understood as limiting, which is explained in more detail in the following with reference to the drawing. In this drawing:

FIG. 1 shows a schematic illustration of the first functional unit of a first exemplary embodiment of a system according to the disclosure,

FIG. 2 shows the data matrix code applied on the number plate according to FIG. 1,

FIG. 3 shows a detail enlargement of the data matrix code from FIG. 2,

FIG. 4 shows a schematic illustration of the second functional unit of a first exemplary embodiment of a system according to the disclosure, and

FIG. 5 shows a schematic illustration of the second functional unit of a second exemplary embodiment of a system according to the disclosure.

### DETAILED DESCRIPTION OF THE DRAWINGS

In the figures, parts which are equivalent in terms of their function are always provided with the same reference numbers, so that the same are generally also only described once.

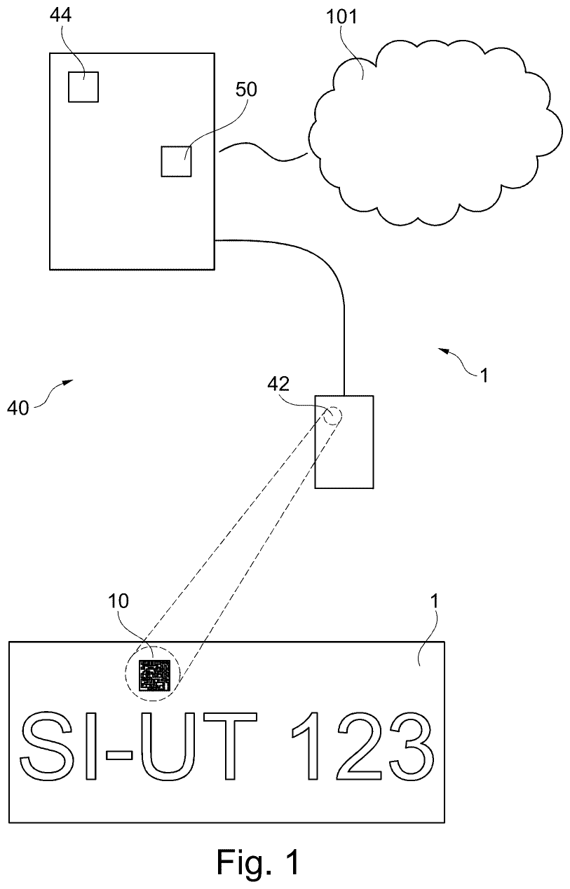

FIG. 1 shows a detail of a first exemplary embodiment of a system 100 according to the disclosure, which is provided for determining a manipulation of an item which is identified using a graphical representation of information. In this case, the manipulation may relate both to the item itself and the information arranged on the item.

The item, which is a motor vehicle number plate 1 in the exemplary embodiment, is identified using a graphical representation of the information in the form of a data matrix code 10. In this case, the data matrix code 10 forms bright and dark areas 11, which are termed modules.

In the exemplary embodiment shown, the data matrix code 10 arranged on the number plate 1 encodes a serial number of the plate of the motor vehicle number plate 1.

The motor vehicle number plate 1 is designed to be retroreflective by means of a glass-bead-based film. Films of this type are based on a multiplicity of transparent and white-coloured (so-called matt) glass beads, the diameter of which typically lies in the range between ten and 100 μm, which glass beads are arranged in a common plane parallel to the plane of the number plate and embedded into a transparent binder layer. The transparent binder layer is mirrored at the rear side by means of a thin metal layer, for example made from aluminium or silver. Glass-bead-based retroreflective films of this type are widely known from the prior art. In this case, on the one hand, the glass beads embedded into the film are arranged irregularly in a certain area, on the other hand, the spatial distribution of transparent and matt glass beads is random and therefore random to a high degree. This leads to the motor vehicle number plate 1 having a surface with an irregular microstructure, which is contrast-imparting to a satisfactory extent, on its retroreflective side. The contrast of the microstructure is deepened further by laser inscription of the film.

In the exemplary embodiment shown, the data matrix code 10 is introduced into the material of the retroreflective film by means of laser inscription. In this exemplary embodiment, the laser inscription is not limited to a purely superficial change of the material of the film. Due to this local, irreversible change of the material of the retroreflective film, a manipulation of the data matrix code, i.e. the graphical encoding of the information (=serial number of the plate) is made more difficult.

In the exemplary embodiment shown, the system 100 according to the disclosure has two functional units 40, 70, which are formed separately from one another.

A first functional unit 40 is provided for carrying out a product registration. It is illustrated in FIG. 1. It is formed as a stationary unit and provided to be arranged preferably spatially adjacent to or in the production facility in which the item identified using the graphical representation of the information, i.e. the motor vehicle number plate 1, is produced.

The first functional unit 40 comprises a separately formed first camera 42, which is in data connection with the first functional unit 40 and is set up to create a photograph of the surface region of the number plate 1, in which the graphical representation of the information, i.e. the data matrix code 10, is arranged, wherein the resolution of the camera 42 is sufficient for resolving the irregular microstructure created by the glass beads embedded in the retroreflective film.

Furthermore, the first functional unit 40 comprises a first analysis unit 44, which is set up to analyse photographs, created by the first camera 42, of the surface region of the number plate 1, in which the graphical representation of the information, i.e. the data matrix code 10, is arranged, in the bright or/and in the dark areas 11 in a spatially resolved manner, in order to generate a first identifier, what is known as the reference identifier, which is directly and uniquely linked to the registered motor vehicle number plate 1.

Furthermore, the first functional unit 40 comprises a data structure 50, in which at least one identifier can be provided. This is formed as a database, which can be addressed by a suitably formed reader via a network, e.g. the internet 101, in order to access data stored in the database, particularly reference identifiers, at least in a reading manner.

The database is stored on a server which is connected to the internet 101 and is reachable via the same from practically any point in the world.

The data structure 50 is designed such that, during the product registration, the reference identifier can be linked in such a manner with the information encoded in the graphical illustration when it is stored in the data structure 50, that it is possible to retrieve the linked reference identifier from the data structure 50 by specifying the information.

The second functional unit 70 is provided for carrying out a product validation in the field, i.e. for examining the authenticity of a motor vehicle number plate which is generally mounted on a motor vehicle.

In contrast to the first functional unit 40, it is formed as a mobile unit. To this end, the second functional unit 70 is formed as a handheld device which is suitable to always be carried by a person entrusted with the examination of motor vehicle number plates.

The second functional unit 70 has a second camera 72, which is integrated into the housing of the second functional unit 70 and like the first camera 42 is set up to create a photograph of the surface region of the number plate 1, in which the graphical representation of the information, that is to say the data matrix code 10, is arranged, wherein the resolution of the second camera 72 is also sufficient for resolving the irregular microstructure.

Furthermore, the second functional unit 70 has a second analysis unit 74, which is set up to analyse photographs, taken by the second camera 72, of the surface region of the number plate, in which the graphical representation of the information is arranged, in the bright or/and in the dark areas 11 in a spatially resolved manner, in order to generate a second identifier, a “test identifier”.

The second test unit 70 furthermore has a decoding unit 76, which is set up to extract from a photograph—which is created by the second camera 72—of the surface region of the number plate 1 in which the graphical representation of the information is arranged, the information encoded therein.

In this case, the second test unit 70 is furthermore set up to provide the information extracted by the decoding unit 76 for further processing. To this end, the second test unit 70 forms an interface for data communication suitable for this, e.g. via near field communication, WiFi, BlueTooth®, or else via a mobile network. IP-based communication is possible via at least one of these interfaces, particularly for access to the internet 101.

Furthermore, the second functional unit 70 comprises a means for retrieving an identifier 78 from the data structure 50. In this case, this means 78 is set up to retrieve in a targeted manner, the reference identifier from the data structure 50, which is stored in the data structure 50 together with the information which is encoded in the graphical identifier and deposited on the number plate 1.

In the second functional unit 70, a comparison unit 80 is furthermore provided, which is set up to execute a method for determining the degree of matching between two identifiers, wherein here these are a reference identifier retrieved from the data structure 50 and the test identifier generated by means of the second functional unit 70.

Finally, a categorization unit 82 is provided in the second functional unit 70, which is set up to categorize the information arranged on the number plate 1 in the form of a data matrix code 10 or/and the number plate 10 itself on the basis of the result of the method executed by the comparison unit 80, as follows:
i. “not manipulated”, if at least one preset minimum degree of matching is achieved, or as
ii. “manipulated”, if a preset minimum degree of matching is not achieved.

In the first or second functional unit 40, 70, the analysis unit 44, 74, the decoding unit 76, the comparison unit 80 and the categorization unit 82 (if present) are realized in a software-implemented manner. The associated software is executed on a CPU, which is arranged, in the case of the second functional unit 70, together with the second camera 72 in a common housing. In the exemplary embodiment shown, the second functional unit 70 is formed as a smartphone. The result determined by the categorization unit 82 is displayed visually on the display 84 of the smartphone.

In the exemplary embodiment shown, at least the second functional unit 70 has position correction means 86. These are set up to carry out a position correction of the photograph to be analysed, during the spatially resolved analysis of a photograph of the surface region of the number plate 1, in which the graphical representation of the information is arranged.

The position correction means 86 are set up to carry out a position correction on the basis of at least a subset of the bright or/and dark areas 11 of the data matrix code 10 located on the number plate 1.

Furthermore, in the exemplary embodiment shown, the second functional unit 70 furthermore has size correction means 88. These are set up to carry out a size correction of the photograph to be analysed during the spatially resolved analysis of the test photograph in the bright or/and in the dark areas 11.

The position correction means 86 and size correction means 88 provided in the second functional unit 70 are used to ensure a matching position and size of the data matrix code 10 both in the reference photograph and the test photograph. It is also provided in the system 1 shown to carry out a registration of the reference photograph and test photograph.

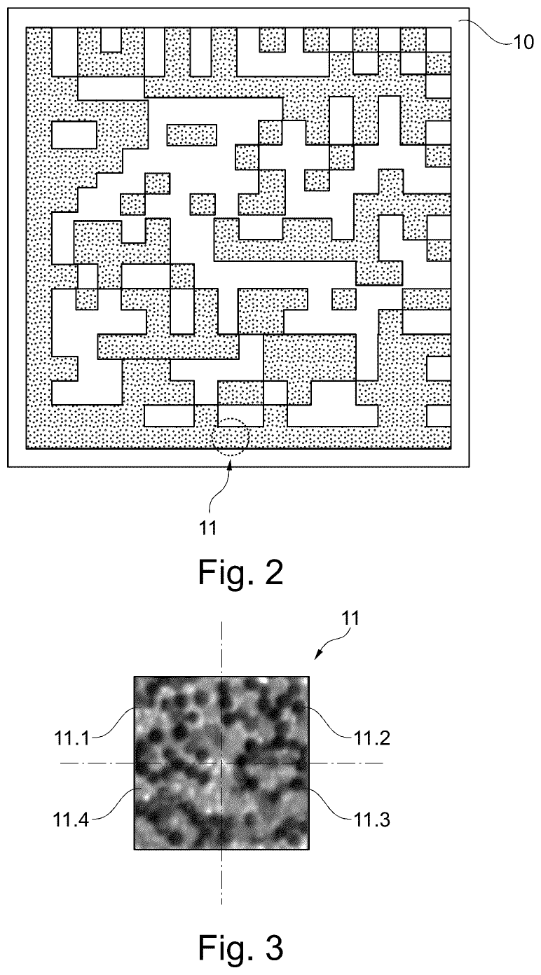

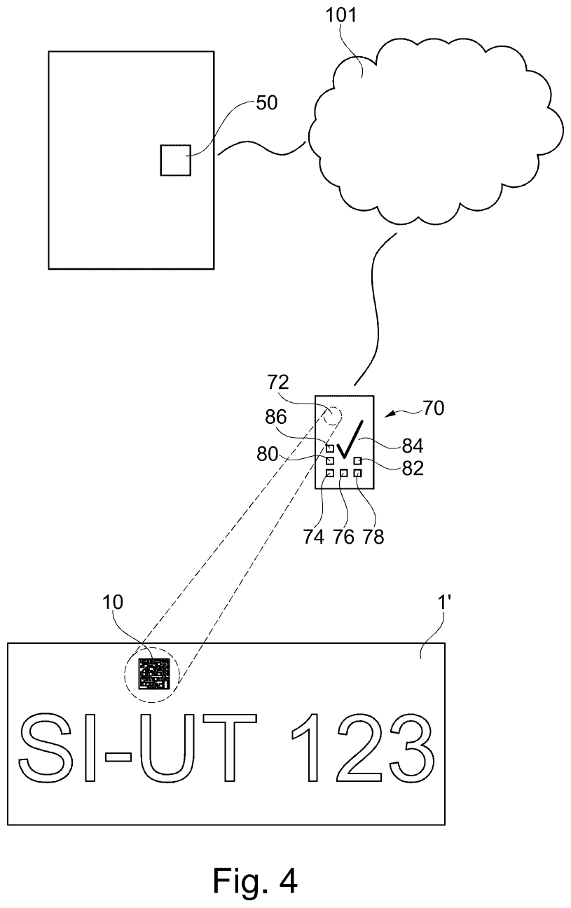

In the system 1 according to the disclosure according to this exemplary embodiment, both analysis units 44, 74 are set up to break down the bright or/and dark areas 11 forming the data matrix code 10, which are also termed modules, into a predetermined number of subsections, during the spatially resolved analysis of a photograph, which is created by one of the cameras 42, 72, of the surface region of the number plate, in which the data matrix code 10 is arranged. A data matrix code basically consists of a structure of n×n squares, which may be bright or dark. A data matrix code 10 according to this exemplary embodiment is illustrated by way of example in FIG. 2. The data matrix code 10 has 10×10 modules 11. In the exemplary embodiment shown, it is provided that each of these modules 11 is again divided regularly into four square subsections 11.1-11.4. A unique identifier is assigned to each of these square subsections 11.1-11.4. By way of example, FIG. 3 shows a randomly selected darkly coloured module 11 of the data matrix code from FIG. 2.

Both analysis units 44, 74 are set up to assign the respectively analysed subsections 11.1-11.4 a brightness value. The resolution of the brightness values is 8 bit. The identifiers generated by the analysis units 44, 74 are based on the unique identifiers of the square subsections 11.1-11.4 and the brightness values, which were assigned to the respective subsections.

Particularly good results could be achieved if the spatially resolved analyses of both the reference photograph and the test photograph were limited to the dark areas 11 of the analysed data matrix code 10. The dark areas 11 of the data matrix code 10 created by means of laser marking of the retroreflective film showed a very well resolvable spatially varying brightness distribution with high contrast, the distribution of which appeared to correlate with the distribution of the underlying glass beads. However, this correlation is unimportant in the scope of the present disclosure, only the presence of an irregular, resolvable brightness distribution is relevant.

An exemplary embodiment of a method according to the disclosure, which is provided for examining the authenticity of a motor vehicle number plate, is specified by way of example below. This method is executed by means of the previously described first exemplary embodiment of a system according to the disclosure. Here, it is again assumed that a graphical representation of the information is present in the form of a data matrix code 10, which as described previously is introduced in the form of laser marking into the glass-bead-based film of a retroreflective motor vehicle number plate 1.

For the product registration of such a motor vehicle number plate 1, the following method steps are executed:
a. creation of a reference photograph, by means of the first camera 42, of the surface region of the number plate 1 in which the data matrix code 10 is arranged,
b. spatially resolved analysis of the reference photograph in the dark areas 11 of the data matrix code 10 by means of the first analysis unit 44, in order to generate a reference identifier,
c. provision of the reference identifier in the data structure 50, which is formed as a database.

The subsequent method steps, which are used for product validation, are executed subsequently, in order to examine whether a number plate 1′—which at least according to a first impression is identical to the number plate 1 identified using the graphical illustration of the information in the first steps—is actually the number plate 1 registered in the context of the product registration or whether the number plate 1′ is identified using the information which was already applied to the registered number plate 1 during the product registration. The method only delivers a positive test result if the validated number plate 1′ is actually the registered number plate and if the product validation shows that the information with which the validated number plate 1′ is identified is identical to the information present on the registered number plate 1 in the registration step.

For the product validation, the following further method steps are executed:
d. creation of a test photograph, by means of the second camera 72, of the surface region of a number plate 1′ to be validated, in which the graphical representation of information, i.e. a data matrix code 10′, is arranged,
e. spatially resolved analysis of the test photograph in the dark areas 11′, in order to generate a test identifier, by means of the second analysis unit 74,
f. decoding of the information from the data matrix code on the basis of the decoding unit 76 provided for this,
g. retrieval of a reference identifier from the data structure 50 on the basis of the information which was decoded from the data matrix code 10′,
h. execution of a method for determining the degree of matching between the test identifier and the reference identifier retrieved from the data structure, by means of the comparison unit 80, and
i. categorization of the information or/and the number plate 1′ by means of the categorization unit 82, as
   A. “not manipulated”, if at least one preset minimum degree of matching is achieved, or
   B. “manipulated”, if a preset minimum degree of matching is not achieved.

The result of the categorization is displayed to a user on the display 84 of the mobile telephone.

In the exemplary embodiment of the method according to the disclosure described here, the reference identifier is stored together with the information in the data structure during the product registration. In a subsequent validation step, the reference identifier is retrieved from the data structure 50 on the basis of the information. This procedure makes it possible to retrieve an identifier stored in the data structure 50 in a targeted resource-saving manner, which identifier is assigned to the item 1 to be validated. In this manner, the method for determining the degree of matching between the test identifier and the reference identifier retrieved from the data structure 50 must only be executed a single time.

Prior to the spatially resolved analysis of the test photograph in the dark areas 11′ of the data matrix code both a position correction and a size correction of the photograph to be analysed are carried out, in order to achieve image registration between reference photograph and test photograph.

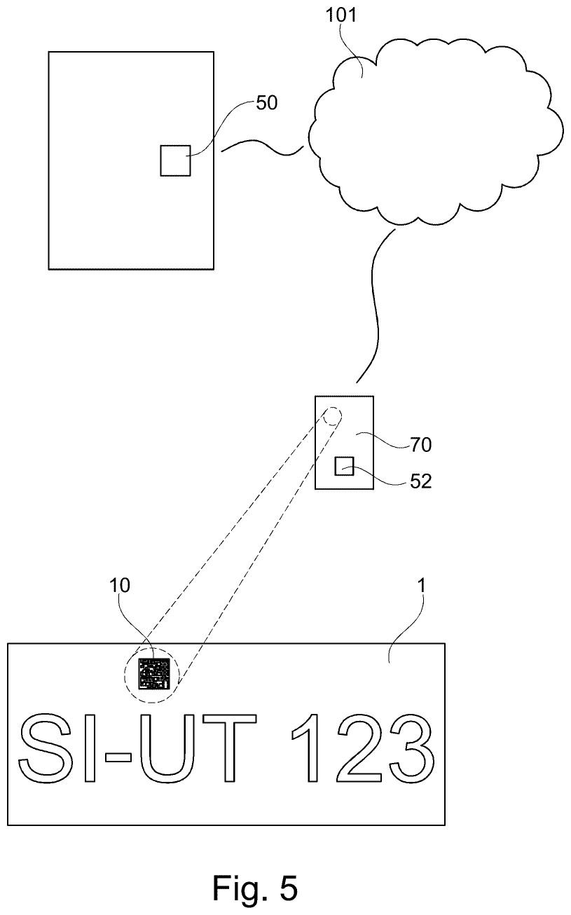

A second exemplary embodiment of a system 1 according to the disclosure is illustrated in FIGS. 1 and 5. The structure thereof in large parts corresponds to that of the system according to the first exemplary embodiment. Matching features are labelled with matching reference numbers.

In particular, the first functional unit 40 of the system according to the second exemplary embodiment is identical to the first functional unit 40 of the system according to the first exemplary embodiment.

The second functional unit 70 of the system according to the second exemplary embodiment by contrast differs, with an otherwise identical structure, from the second functional unit 70 of the system according to the first exemplary embodiment, in that the second functional unit 70 does not require permanent access to the data structure 50 which is accessible via the internet 101.

To this end, a data structure 52 is arranged on the second functional unit 70, which constitutes a complete copy of the data structure 50. During product validation, it is not the data structure 50, but rather the locally held data structure 52 which is accessed.

If internet access is available to the second functional unit 70, then a comparison of the locally held data structure 52 with the “global” data structure 52 is carried out at suitable intervals.

The system according to the disclosure disclosed in the exemplary embodiments and also the method according to the disclosure disclosed herein are not limited in terms of the scope of the disclosure to the embodiments respectively disclosed herein, but rather also comprise further embodiments with the same effect, which emerge from technically sensible further combinations of the features of the system and of the method described herein. In particular, the features and feature combinations mentioned previously in the general description and the description of the figures and/or solely shown in the figures can be used not only in the combinations respectively explicitly specified herein, but rather also in other combinations or in isolation, without departing from the scope of the present disclosure.

1. A method for determining a manipulation or forgery of an item which is identified using a graphical representation of information, the graphical representation of the information forming bright and dark areas and the item having a surface with a contrast-imparting irregular microstructure, having the following method steps:
a. creation of a first photograph of the surface region of an item to be registered, in which the graphical representation of the information is arranged,
b. provision of the reference identifier in a data structure,
c. creation of a second photograph of the surface region of an item to be validated, in which the graphical representation of information is arranged, both the item and the information with the item registered in steps a. to c. or the information arranged on the same being identical, at least from first impression,
f. retrieval of a reference identifier from the data structure, and
e. execution of a method for determining the degree of matching between the test identifier generated from the second photograph and the reference identifier retrieved from the data structure,
wherein the surface of the item is coated with a glass-bead-based retroreflective film, which forms the irregular microstructure, wherein the graphical representation of the information is arranged such on the item that the irregular microstructure is interleaved with the graphical representation of the information, and wherein the following method steps are carried out for generating the reference identifier and the test identifier;
f. spatially resolved analysis of the first photograph in the bright or/and in the dark areas and generation of the reference identifier, and
g. spatially resolved analysis of the second photograph of the surface region in the bright or/and in the dark areas and generation of the test identifier.

2. The method according to claim 1, further including the following method step:
h. categorization of the item to be validated as
i. “not manipulated”, if at least one preset minimum degree of matching is achieved, or
ii. “manipulated”, if a preset minimum degree of matching is not achieved.

3. The method according to claim 1, wherein in a preceding method step, a graphical representation of the information is created, in plain text or in the form of a 1D code, such as a barcode, or in the form of a 2D code, such as a QR code or a data matrix code.

4. The method according to claim 1, wherein in a preceding method step, the item is identified using a graphical representation of the information, wherein the graphical representation of the information forms bright and dark areas.

5. The method according to claim 1, wherein the data structure is located on the item.

6. The method according to claim 1, wherein the data structure is formed separately from the item.

7. The method according to claim 1, wherein
a. the reference identifier is stored together with the information in the data structure, and in that
b. the reference identifier is retrieved from the data structure in step i. on the basis of the information.

8. The method according to claim 1, wherein the information relates to at least one of the following parameters:
a. a serial number of the item or a further item correlated with the item, and
b. the identity of the holder of the item.

9. The method according to claim 1, further including the following method step:
a. extraction of the information encoded in the graphical representation of the information, and
b. provision of the extracted information for further processing.

10. (canceled)

11. The method according to claim 1, wherein the item is an identification document, a means of payment, or a motor vehicle number plate.

12. The method according to claim 1, wherein a position correction of the photograph to be analysed is carried out during the spatially resolved analysis of the first or second photograph in the bright or/and in the dark areas.

13. The method according to claim 1, wherein a size correction of the photograph to be analysed is carried out during the spatially resolved analysis of the first or second photograph in the bright or/and in the dark areas.

14. The method according to claim 12, wherein the position or/and size correction is carried out on the basis of at least a subset of the bright or/and dark areas.

15. The method according to claim 1, wherein during the spatially resolved analysis of the first or second photograph in the bright or/and in the dark areas, the analysed bright or/and dark areas are broken down into a predetermined number of subsections.

16. The method according to claim 15, wherein during the spatially resolved analysis of the first or second photograph in the bright or/and in the dark areas, a brightness or colour value is assigned to the analysed subsections.

17. The method according to claim 16, wherein the generated identifier is at least also based on the assigned brightness or colour values.

18. The method according to claim 17, wherein the generated identifier is furthermore based on identifiers which identify the analysed subsections.

19. A system for examining a forgery proof identification of an item using information, the item being identified using a graphical representation of the information, in the form of a barcode, a QR code or a data matrix code with the formation of bright and dark areas, the item having a surface with a contrast-imparting irregular microstructure, the system having the following components:
a. a camera, which is suitable for creating a photograph of the surface region of the item, in which the graphical representation of the information is arranged, the resolution of the camera being sufficient for resolving the irregular microstructure,
b. a data structure, in which at least one identifier can be provided,
c. a decoding unit (76), which is set up to extract the information from a photograph—which is created by the camera of the surface region of the item, in which the graphical representation of the information is arranged, and to provide the information for further processing,
d. a comparison unit, which is set up for executing a method for determining the degree of matching between two identifiers generated from different photographs of the surface region of the item in which the graphical representation of the information is arranged,
wherein the surface of the item is coated with a glass-bead-based retroreflective film, which forms the irregular microstructure, wherein the graphical representation of the information is arranged such on the item that the irregular microstructure is interleaved with the graphical representation of the information, wherein the system further has the following component:
e. an analysis unit, which is set up to analyse photographs, taken by the camera, of the surface region of the item, in which the graphical representation of the information is arranged, in the bright or/and in the dark areas in a spatially resolved manner, in order to generate an identifier.

20. The system according to claim 19, wherein the system furthermore comprises a categorization unit, which is set up to categorize the extracted information on the basis of the result of the method executed by the comparison unit, as follows:
i. “not manipulated”, if at least one preset minimum degree of matching is achieved, or as
ii. “manipulated”, if a preset minimum degree of matching is not achieved.

21. The system according to claim 19, wherein the system furthermore has means for retrieving an identifier from the data structure.

22. The system according to claim 19, wherein the system has a non-volatile memory unit for accommodating the data structure.

23. The system according to claim 22, wherein the non-volatile memory unit is arranged on the item.

24. The system according to claim 22, wherein the non-volatile memory unit is formed separately from the item.

25. The system according to claim 19, wherein the data structure is set up such that an identifier can be stored together with the information in the data structure.

26. The system according to claim 23, wherein the data structure is set up such that an identifier stored in the data structure can be retrieved from the data structure on the basis of the information.

27. The system according to claim 19, wherein the information relates to at least one of the following parameters:
a. a serial number of the item or a further item correlated with the item, and
b. the identity of the holder of the item.

28. (canceled)

29. The system according to claim 19, wherein the item is an identification document, a means of payment, or a motor vehicle number plate.

30. The system according to claim 19, wherein the system has position correction means, which are set up to carry out a position correction of the photograph to be analysed during the spatially resolved analysis of a photograph of the surface region of the item, in which the graphical representation of the information is arranged.

31. The system according to claim 19, wherein the system has size correction means, which are set up to carry out a size correction of the photograph to be analysed during the spatially resolved analysis of a photograph of the surface region of the item, in which the graphical representation of the information is arranged.

32. The system according to claim 30, wherein the position correction means or/and the size correction means are set up to carry out the position correction or/and the size correction on the basis of at least a subset of the bright or/and dark areas.

33. The system according to claim 19, wherein the analysis unit is set up, during the spatially resolved analysis of a photograph, created by the camera, of the surface region of the item in which the graphical representation of the information is arranged, to break down the analysed bright or/and dark areas into a predetermined number of subsections.

34. The system according to claim 33, wherein the analysis unit is set up to assign a brightness or colour value to the analysed subsections.

35. The system according to claim 34, wherein an identifier generated by the analysis unit is at least also based on the assigned brightness or colour values.

36. The system according to claim 34, wherein an identifier generated by the analysis unit is furthermore based on identifiers which identify the analysed subsections.
